(19) United States
(12) Patent Application Publication
(10) Pub. No.: US 2024/0427105 A1
(43) Pub. Date: Dec. 26, 2024

(54) FIBER OPTIC ENCLOSURE WITH FIBER TUBES SEALED OUTSIDE THE ENCLOSURE

(71) Applicant: CommScope Technologies LLC, Hickory, NC (US)

(72) Inventors: Philippe COENEGRACHT, Hasselt (BE); Olivier C. ROCHE, Schaerbeek (BE)

(73) Assignee: CommScope Technologies LLC, Hickory, NC (US)

(21) Appl. No.: 18/706,616

(22) PCT Filed: Nov. 1, 2022
(86) PCT No.: PCT/US2022/048602

§ 371 Date: May 1, 2024

Related U.S. Application Data
(60) Provisional application No. 63/274,451, filed on Nov. 1, 2021.
(60) Provisional application No. 63/329,684, filed on Apr. 11, 2022.

(51) Int. Cl. G02B 6/44; G02B 6/52

(52) U.S. Cl. CPC G02B 6/44775; G02B 6/52

(57) ABSTRACT

The present disclosure relates to systems for sealing the ends of fiber tubes such as fiber tubes used to receive blown optic fibers (e.g., fiber cables). The present disclosure also relates to systems for facilitating fixation of fiber tubes and fiber cables with respect to an enclosure.

### CROSS-REFERENCE TO RELATED APPLICATIONS

This application is being filed on Nov. 1, 2022 as a PCT International Patent Application and claims the benefit of U.S. Patent Application Ser. No. 63/274,451, filed on Nov. 1, 2021 and claims the benefit of U.S. Patent Application Ser. No. 63/329,684, filed on Apr. 11, 2022, the disclosures of which are incorporated herein by reference in their entireties.

### TECHNICAL FIELD

The present disclosure relates to telecommunication enclosures for fiber optic systems.

### BACKGROUND

Different architectures and systems have been developed for facilitating the deployment of fiber optic networks. One type of system architecture can be referred to as a blown fiber system. An example blown fiber system can include a conduit through which one or more blown fiber tubes are routed at a first date. The blown fiber tubes and the conduit extend between a first location (e.g., a more centralized location such as cabinet, hub, etc.) and a second location (e.g., a location closer to a periphery of the network than the first location and often in the vicinity of subscriber locations). At a second date, when it is desired to provide fiber optic service to subscribers near the second location, optical fibers can be blown through the pre-installed blown fiber tubes from the first location to the second location.

### SUMMARY

The present disclosure relates to systems for sealing the ends of fiber tubes such as fiber tubes used to receive optic fibers (e.g., fiber cables).

The present disclosure also relates to systems for facilitating fixation of fiber tubes and fiber cables with respect to an enclosure.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 depicts a fiber system in accordance with the principles of the present disclosure prior to deployment of optical fibers therein;

FIG. 2 depicts the fiber system of FIG. 1 after deployment of optical fibers therein;

FIG. 3 depicts another fiber system in accordance with the principles of the present disclosure prior to deployment of optical fibers therein;

FIG. 4 depicts the fiber system of FIG. 3 after deployment of optical fibers therein;

FIG. 5 is a transverse cross-sectional view of a fiber cable usable in systems in accordance with the principles of the present disclosure;

FIG. 6 is a partially exploded view of a fiber tube sealing unit in accordance with the principles of the present disclosure;

FIG. 7 is a view of an opposite side of the fiber tube sealing unit of FIG. 6;

FIG. 8 is a partially exploded view of FIG. 7;

FIG. 9 shows fiber sealing units in accordance with the principles of the present disclosure mounted to a mounting bracket;

FIG. 10 shows the mounting bracket of FIG. 9 attached to a telecommunication housing;

FIG. 11 depicts an example sealant arrangement for the fiber tube sealing unit of FIG. 6;

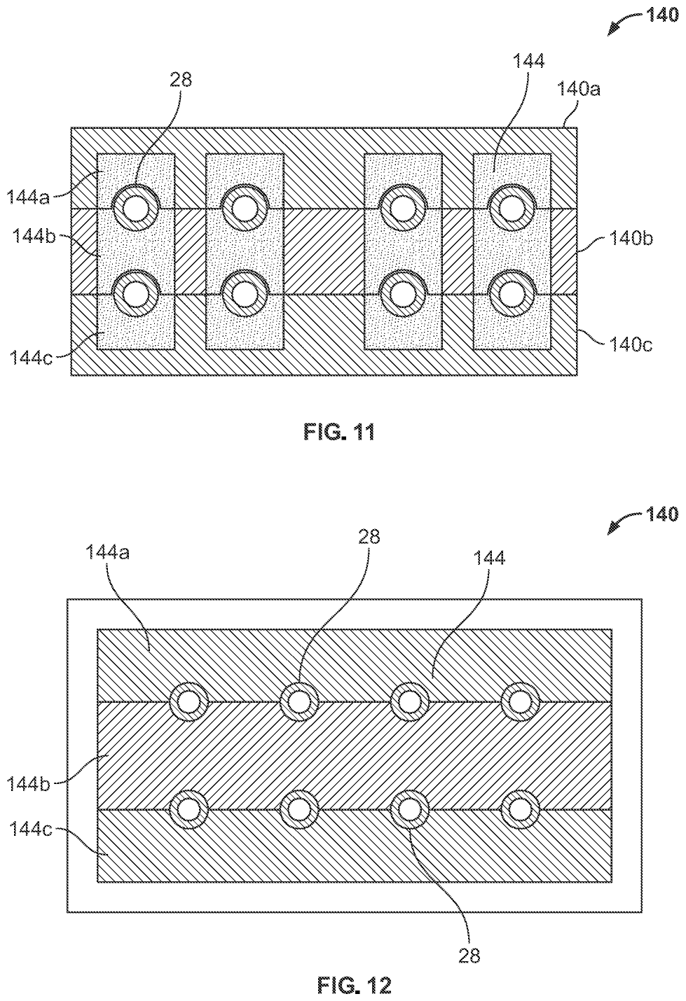

FIG. 12 depicts another example sealant arrangement for fiber tube sealing units in accordance with the principles of the present disclosure:

FIG. 13 is a side view of a fixation component in accordance with the principles of the present disclosure;

FIG. 14 is a perspective view of the fixation component of FIG. 13;

FIG. 15 depicts the fixation component of FIGS. 13 and 14 with a fiber tube and a fiber cable fixed thereto;

FIGS. 16 and 17 show the arrangement of FIG. 15 installed in a telecommunication housing;

FIG. 18 depicts a tube arrangement in accordance with the principles of the present disclosure;

FIG. 19 depicts the tube arrangement of FIG. 18 secured to a first mounting bracket adapted for facilitating attaching the tube arrangement to a bracket arrangement of an enclosure;

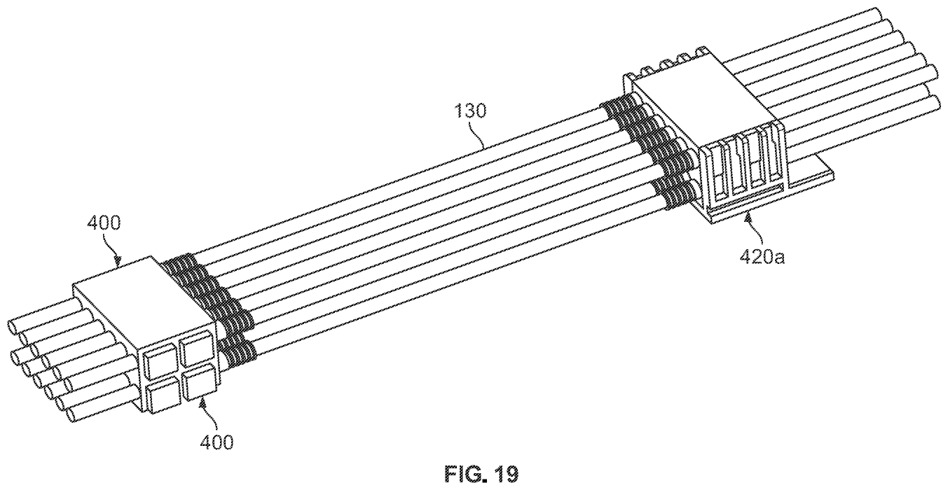

FIG. 20 depicts the tube arrangement of FIG. 18 secured to a bracket arrangement of an enclosure and also secured to a tube sealing unit, tubes of the tube arrangement are shown extending through a sealing module of a cable sealing arrangement of the enclosure; and

FIG. 21 depicts the tube arrangement of FIG. 18 secured to a bracket arrangement of an enclosure and also secured to a tube sealing unit, tubes of the tube arrangement are shown terminating before entering a sealing module of a cable sealing arrangement of the enclosure.

### DETAILED DESCRIPTION

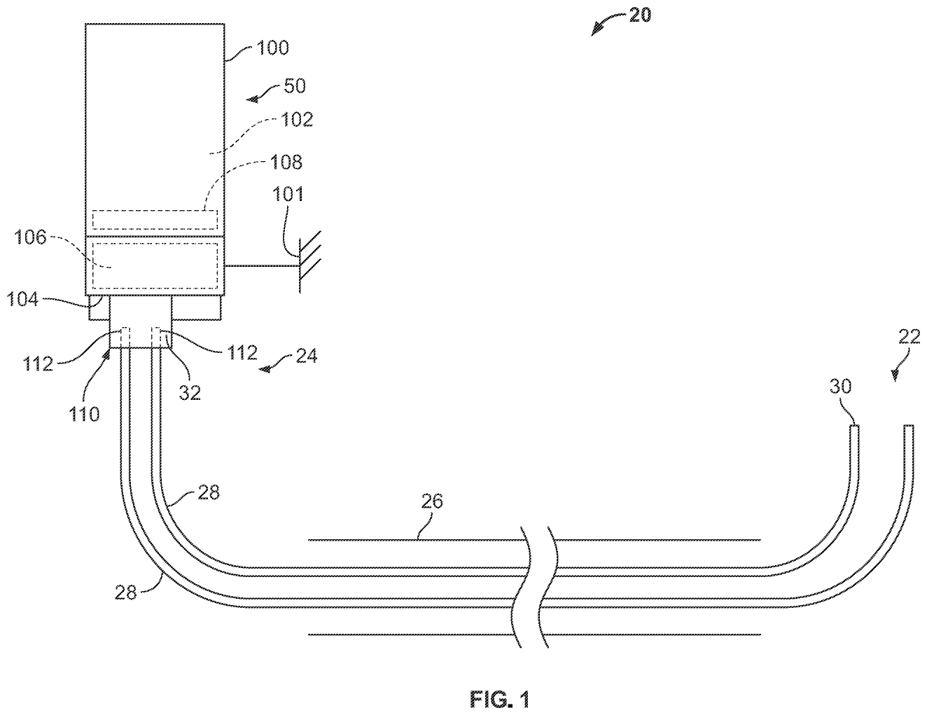

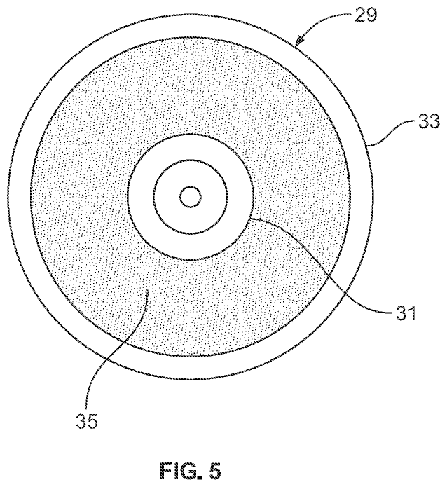

FIG. 1 depicts an example fiber system 20 in accordance with the principles of the present disclosure prior to optical fibers being deployed through the system. The system 20 includes a first location 22 and a second location 24. A conduit 26 (e.g., an underground conduit) is routed at least partially between the first and second locations 22, 24. The conduit 26 contains a plurality of fiber tubes 28 routed through the conduit 26 between the first and second locations 22, 24. In one example, the fiber tubes 28 are blown fiber tubes configured for allowing optical fibers (e.g., blown optical fiber cables 29) to be blown therethrough to deploy the optical fibers. In one example each fiber tube has an outer diameter of about 7 millimeters (mm) and an inner diameter of about 4 mm. In another example each fiber tube has an outer diameter of about 5 mm and an inner diameter of about 3 millimeters. In certain examples, fiber cables such as the cable 29 depicted at FIG. 5 are routed through the fiber tubes. Preferably, the cables 29 are deployed through the fiber tubes 28 by blowing, but in other examples the cables could be pushed or pulled through the fiber tubes 28. In certain examples, the cables 29 can have an outer diameter less than or equal to 2 millimeters. As shown at FIG. 5, the cable 29 includes an optical fiber 31 contained within a jacket 33, and also includes tensile reinforcing elements 35 such as yarn (e.g., aramid yarn) within the jacket 33.

In one example, the first location 22 is more centrally located in the network than the second location 24 and the second location 24 is closer to a periphery of the network than the first location 22. In one example, the first location 22 is a fiber distribution point such as a cabinet or hub and the second location 24 is in the vicinity of subscriber locations or future subscriber locations. Typically, a plurality of the fiber tubes is routed through the conduit for providing fiber optic service to different locations along the length of the conduit 26.

The fiber tubes 28 each include a first end 30 that can be accessed at the first location 22 and a second end 32 that can be accessed adjacent the second location 24. It will be appreciated that the fiber tubes 28 can also be routed through or to additional structures such as enclosures/terminals, hand holes and the like.

FIG. 1 shows the system 20 at the time of initial deployment in which a telecommunication enclosure 50 has been installed at the second location 24. As depicted, the fiber cables 29 have not yet been deployed through the fiber tubes 28. The telecommunication enclosure 50 can contain fiber optic components such as fiber storage structures, splice trays, passive optical power splitters and wavelength division multiplexers. At the enclosure 50, optical fibers routed through fiber tubes can be optically coupled to the input of a passive optical splitter having outputs that are optically connected to optical fibers routed to subscriber locations (e.g., through blown fiber tubes integrated with the enclosure, or via optical cables routed into the enclosure or coupled to the enclosure at hardened adapter ports). In other examples, the optical fiber can be spliced directly to an optical fiber routed to a subscriber location via a fiber tube or through a cable routed into the enclosure or coupled to the enclosure at a hardened adapter port.

The enclosure 50 includes a telecommunication housing 100 defining an interior 102. The telecommunication housing 100 includes a cable entrance location 104 at which a cable sealing arrangement 106 is located for sealing about cables routed through the cable entrance location 104 into the interior 102 of the telecommunication housing 100. In certain examples, the cable sealing arrangement 106 includes sealing gel such as thermoplastic elastomeric gel or silicone gel that may be arranged as a sealing block including one or more gel sealing modules. The enclosure 50 also includes a cable fixation region 108 located within the interior of the telecommunication housing 100. The telecommunication housing 100 is shown mounted to another structure 101 such as a pole, wall, cable, carrier wire, hand-hole or the like.

The system 20 also includes a tube sealing unit 110 for receiving ends 112 of a plurality of the fiber tubes 28. The tube sealing unit 110 is located outside the telecommunication housing 100 and includes sealant (e.g., an elastomeric material such as gel) for sealing the ends of the fiber tubes 28. The tube sealing unit 110 is supported by the telecommunication housing 100 (e.g., the weight of the tube sealing unit 110 is transferred through the telecommunication housing to the structure 101). The tube sealing unit 110 can be mounted to the telecommunication housing 100 by an intermediate bracket, flange, or other structure.

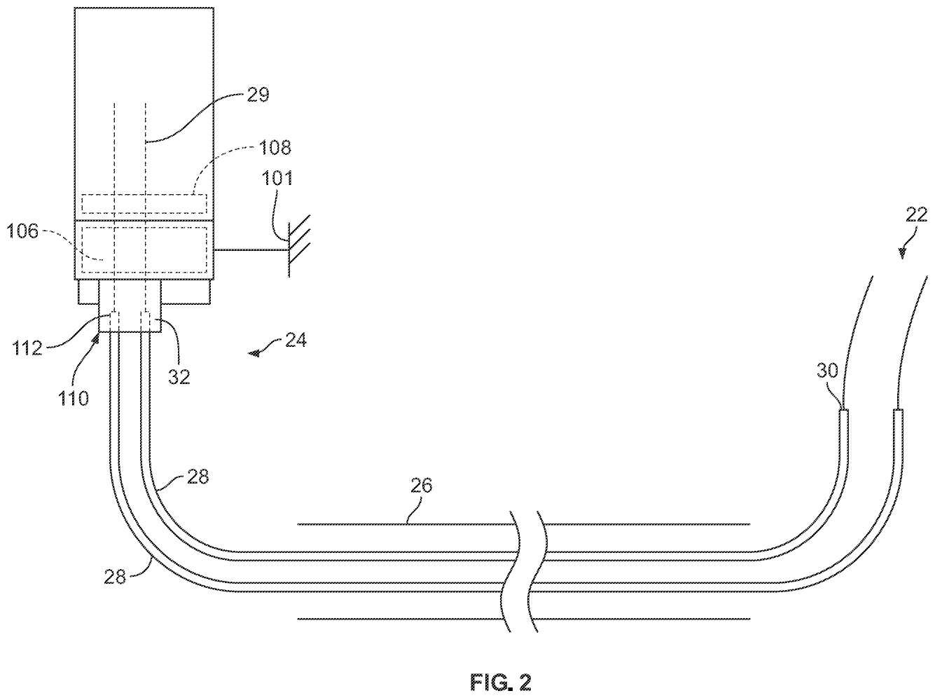

FIG. 2 shows the system 20 after the fiber cables 29 have been deployed. As depicted, the fiber tubes 28 have ends 112 located within the tube sealing unit 110 that are sealed by the sealant of the tube sealing unit 110. The fiber cables 29 extend through the fiber tubes 28 and out of the ends 112 of fiber tubes 28. The fiber cables 29 extend through the sealant of the tube sealing unit 110 and out of the tube sealing unit 110. The fiber cables 29 extend from the tube sealing unit 110 into the interior 102 of the telecommunication housing 100 through the cable sealing arrangement 106 which provides sealing about the fiber cables 29. The fiber cables 29 are fixed relative to the telecommunication housing 100 at the cable fixation region 108 within the interior of the housing 100. In one example, the jacket and/or the strength elements of the fiber cable 29 are secured relative to the telecommunication housing 100 by strapping, clamping, tying or other techniques.

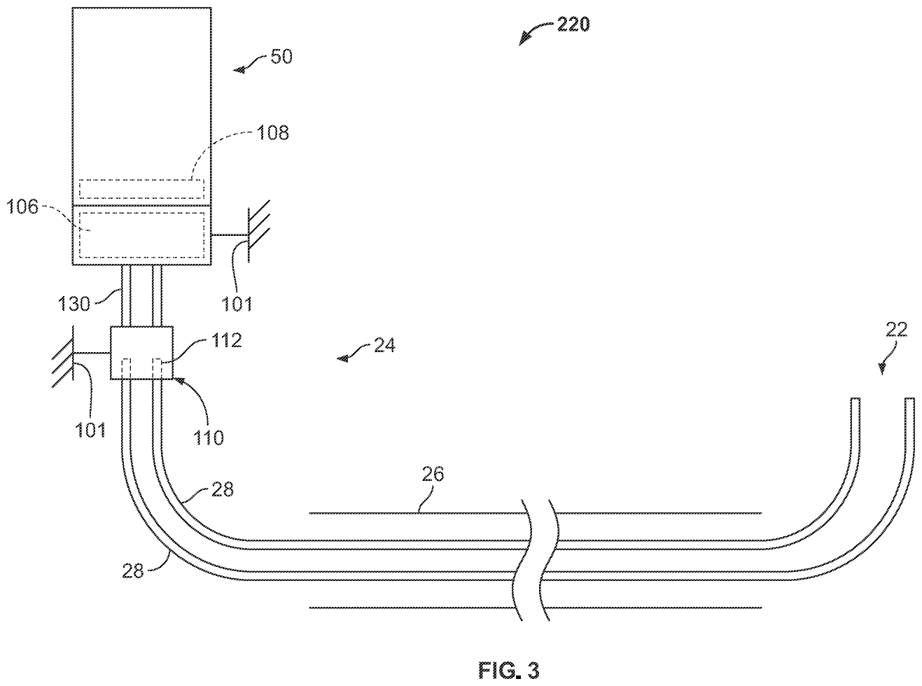

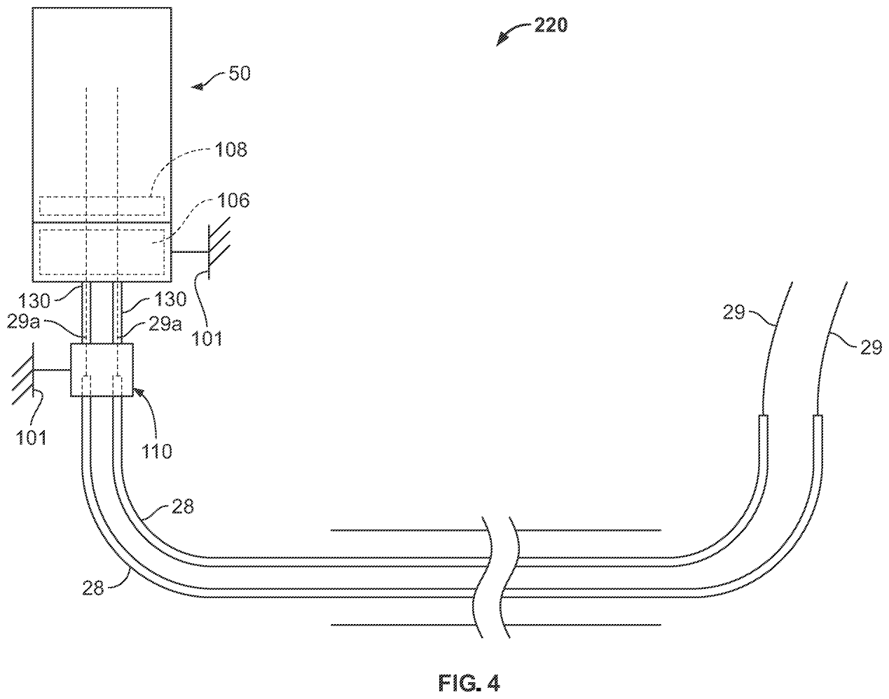

FIGS. 3 and 4 depict another system 220 in accordance with the principles of the present disclosure. The system 220 has the same configuration as the system 20, except the tube sealing unit 110 is not supported by the telecommunication housing 100 and is separately mounted to and supported by a structure 101. The structure 101 can be the same structure that the terminal housing 100 is mounted to, or a different structure. Protective tubes 130 are routed between the tube sealing unit 110 and the telecommunication housing 100 for protecting the portions of the fiber cables 29 that extend between the tube sealing unit 110 and the telecommunication housing 100. In certain examples, the protective tubes 130 are more flexible than the fiber tubes 28. In certain examples, the protective tubes 130 each have a wrap-around configuration which allows the tubes 130 to be opened along their lengths (e.g., along a longitudinal seam) to allow the fiber cables 29 to be laterally inserted into the tubes 130.

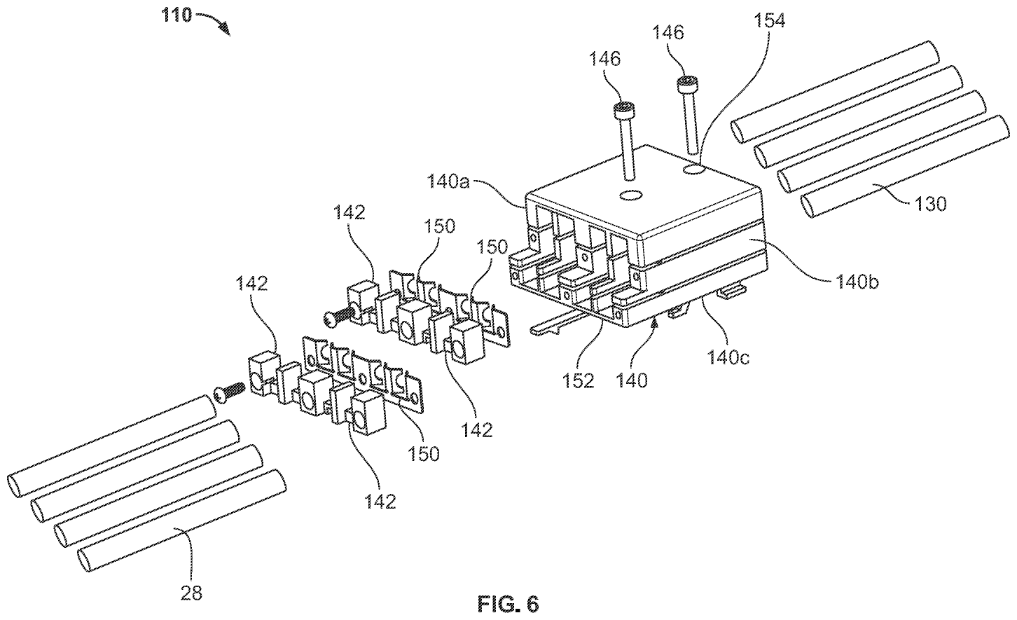

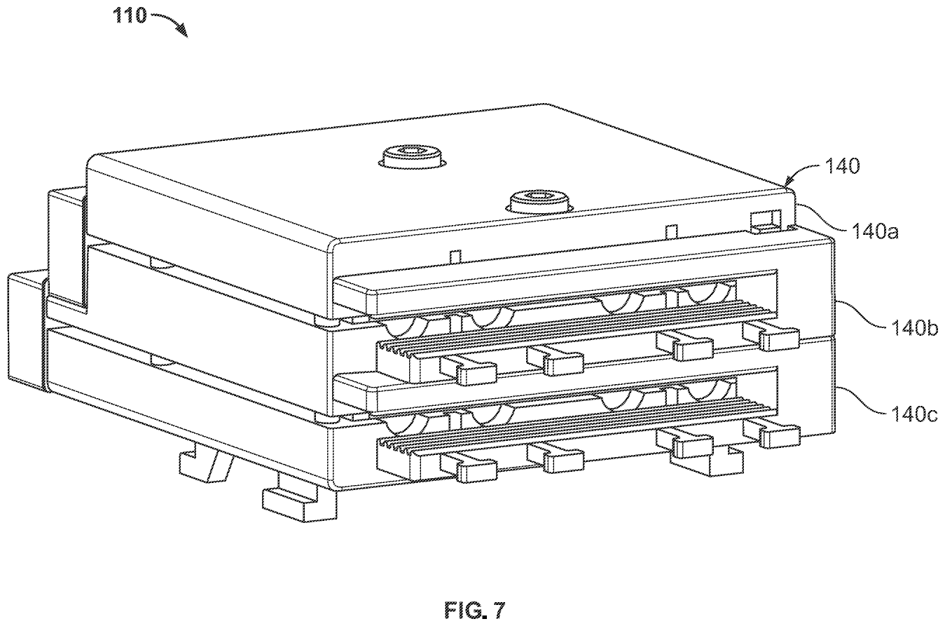

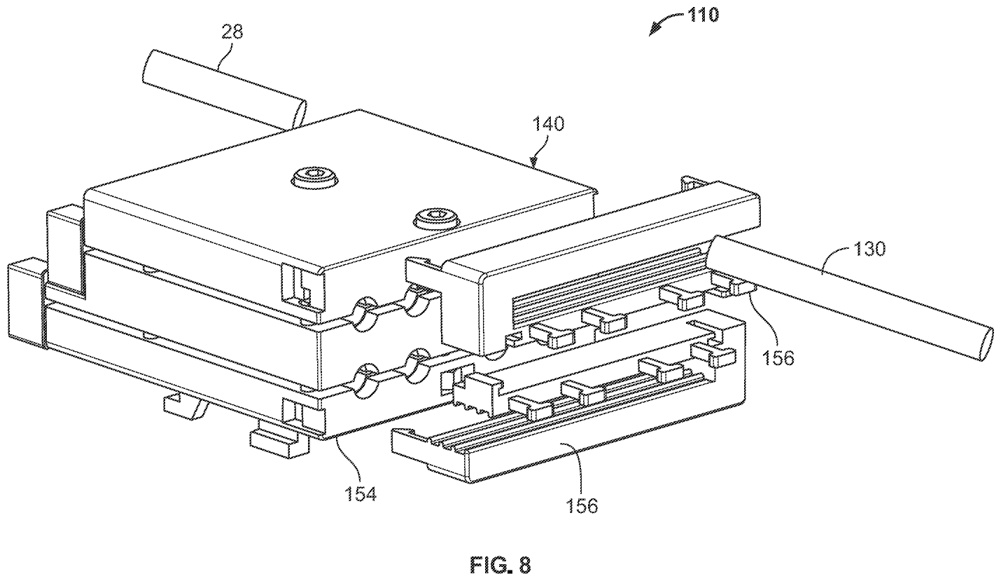

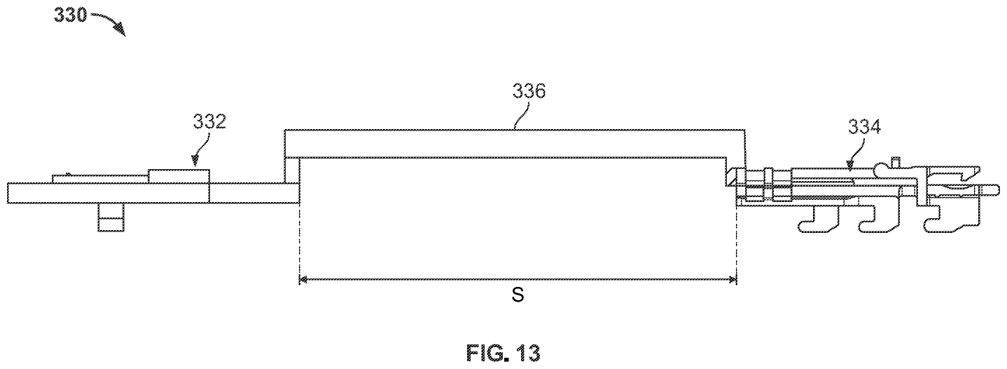

FIGS. 6-8 depict an example version of the tube sealing unit 110. The tube sealing unit 110 includes a tube sealing housing 140 defining a plurality of tube receiving locations 142 each configured for receiving one of the fiber tubes. The tube sealing unit 110 also includes sealant 144 (e.g., an elastomeric material such as a sealing gel) within the tube sealing housing 140 for sealing the ends of the fiber tubes 28 within the tube sealing housing 140. The tube sealing housing 140 can have a molded plastic configuration and can include a plurality of housing pieces that are joined together (e.g., clamped together by fasteners 146 such as bolts, latches, or other structures) to pressurize the sealant 144 and cause the sealant to deform about the ends 112 of the fiber tubes 28 to provide sealing. In one example, the tube sealing housing 140 includes three pieces 140a, 140b, 140c (e.g., segments) each including corresponding sections of sealant 144a, 144b, 144c between which the ends 112 of the fiber tubes 28 are sealed. FIG. 12 depicts a tube sealing housing 140 having two housing pieces 140a, 140b containing three layers 144a, 144b, 144c of sealant 144 between which the ends 112 of the fiber tubes 28 are sealed.

The tube sealing unit 110 includes tube fixation structures 150 at each of the tube receiving locations 142 for securing the fiber tubes 28 to the tube sealing housing 140. In the depicted example, the tube fixation structures 150 include blades adapted to embed within the fiber tube 28 to provide axial retention of the fiber tubes 28. In other examples, the fixations structures can include locations for clamping, tying, or strapping the fiber tube 28 to the tube sealing housing 140. The tube fixation structures 150 are at one side 152 of the tube sealing housing 140 and the fiber cables 29 exit the tube sealing housing 140 at an opposite side 154 of the tube sealing housing 140. Fixation structures 156 can be provided at the side 154 for attaching the protective tubes 130 to the tube sealing housing 140. It will be appreciated that protective tubes would typically be used in the system 220 of FIGS. 3 and 4, and preferably would not be used when the tube sealing housing 140 is mounted to the telecommunication housing 100. The fixation structure 156 can be removeable.

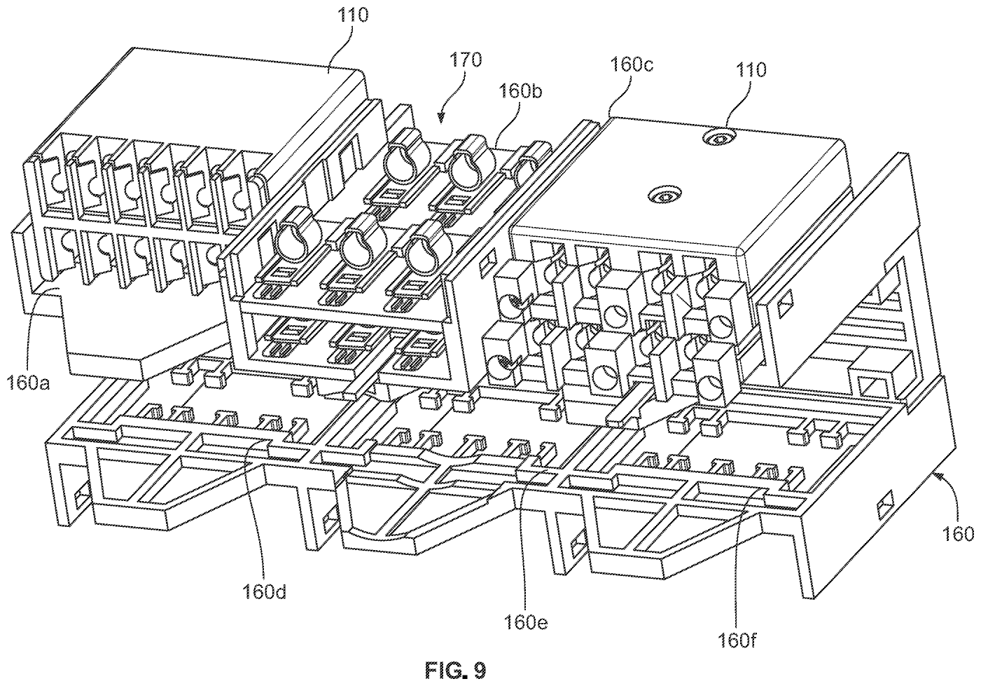

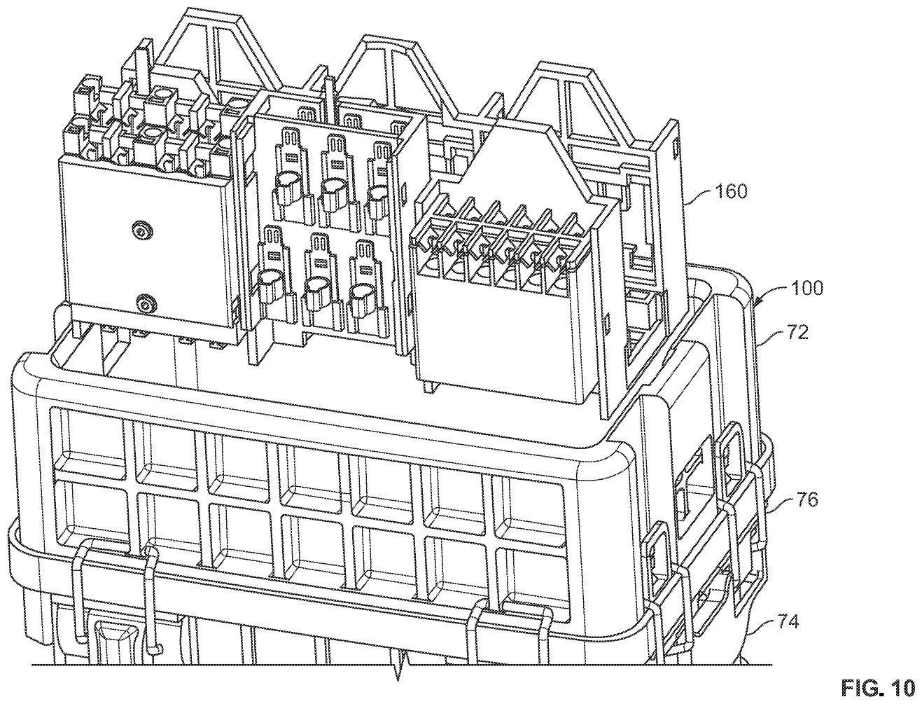

The tube sealing housing 140 can be mounted to the telecommunication housing 100 or the structure 101 either directly or through an intermediate structure such as a bracket 160 (See FIGS. 9 and 10). The tube sealing housing 140 can includes latches, snaps, fastener openings, fastening tabs or other structure for facilitating attaching the tube sealing housing 140 to the telecommunication housing 100 or the structure 101.

It will be appreciated that the tube sealing housing 140 can be considered as a module and can be used in combination with other types of modules having different functionality. As shown at FIG. 10, the bracket 160 is configured to mount to the telecommunication housing 100 and defines a plurality of module mounting locations 160a-160f. Two of the tube sealing modules 140 and one cable anchoring module 170 are shown concurrently secured to the bracket 160 at FIG. 10.

As depicted at FIG. 10, the telecommunication housing 100 has a base 72 and a cover 74 (e.g., a dome). The base and the cover can be coupled together in a manner that allows the base and the cover to be detached from one another to access the interior of the housing 100. For example, latches 76 can be provided for latching the base 72 and the cover 74 together. In other examples, clamps, fasteners such as bolts or other structures can be used to secure the base 72 and the cover 74 together. A perimeter seal (e.g., a gasket) can be provided for sealing between the base 72 and the cover 74. The cable sealing arrangement 106 can be housed in the base 72.

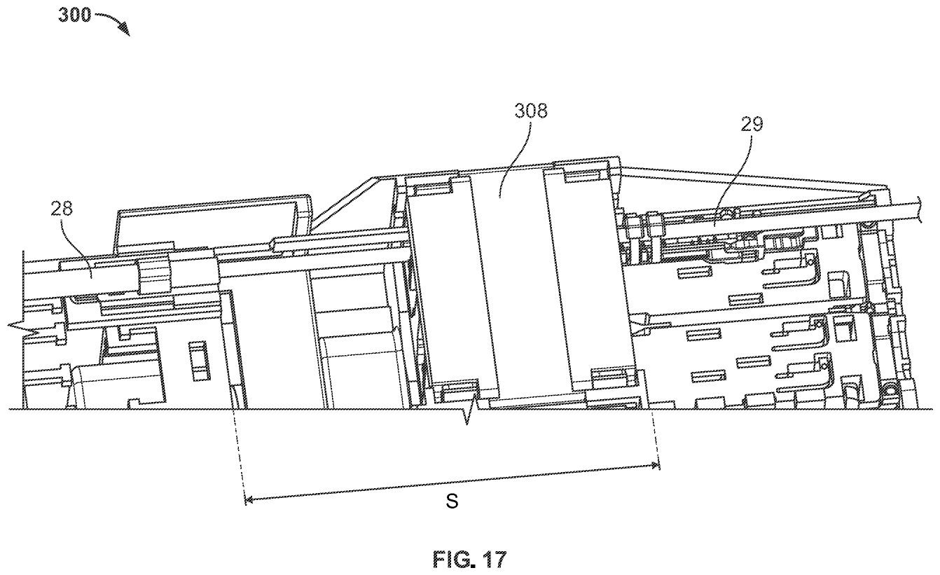

Aspects of the present disclosure also relate to a system for facilitating fixation of fiber tubes 28 and fiber cables 29 with respect to an enclosure. FIGS. 16 and 17 depict an enclosure 300 including a telecommunication housing 302 defining an interior 304. The telecommunication housing 302 includes a cable entrance location 306 at which a cable sealing arrangement 308 is located for sealing about the fiber cables 29 when the fiber cables 29 are routed through the cable entrance location 306 into the interior 304 of the telecommunication housing 302. The enclosure 300 includes a cable fixation region 310 located within the interior 304 of the telecommunication housing 302 for securing the fiber cables 29 with respect to the telecommunication housing 302. The enclosure 300 also including a fiber tube fixation region 312 located outside the telecommunication housing 302 for securing the fiber tubes 28 with respect to the terminal housing 302. The cable fixation region 310 has a plurality of cable fixation stations 314 at which cable fixation modules 316 can be mounted (e.g., by an interlocked connection such as a snap-fit or latched interlock or a slide interlock) and the fiber tube fixation region 312 includes a plurality of fiber tube fixation stations 318 at which fiber tube fixation modules 320 can be mounted (e.g., by an interlocked connection such as a snap-fit or latched interlock). Each of the cable fixation stations 314 is spaced from a corresponding one of the fiber tube fixations stations 318 by a first spacing S. In one example, the module interlocks can be engaged by vertically pressing the modules into their corresponding fixation stations.

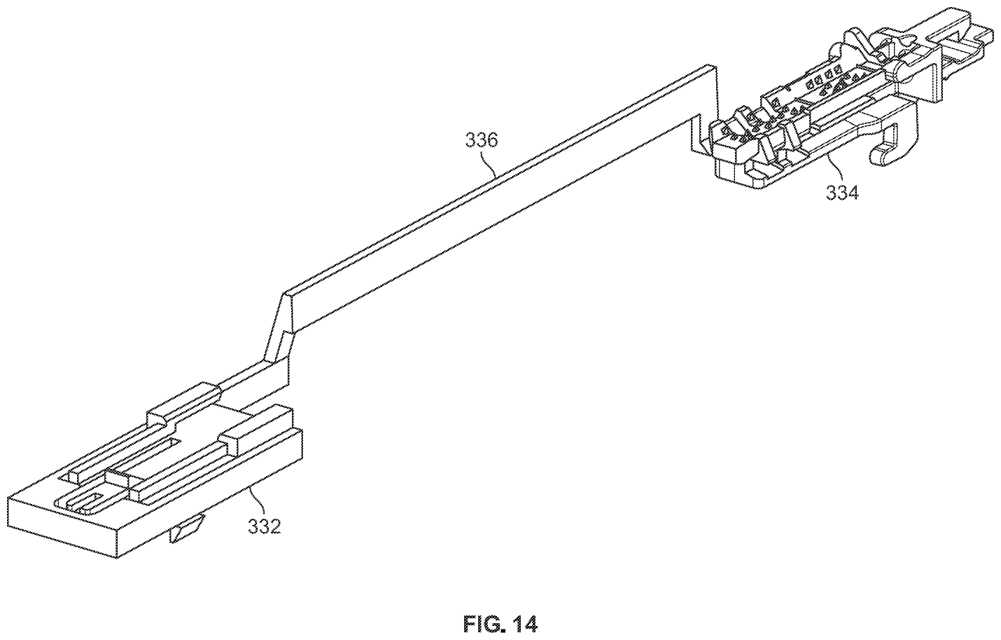

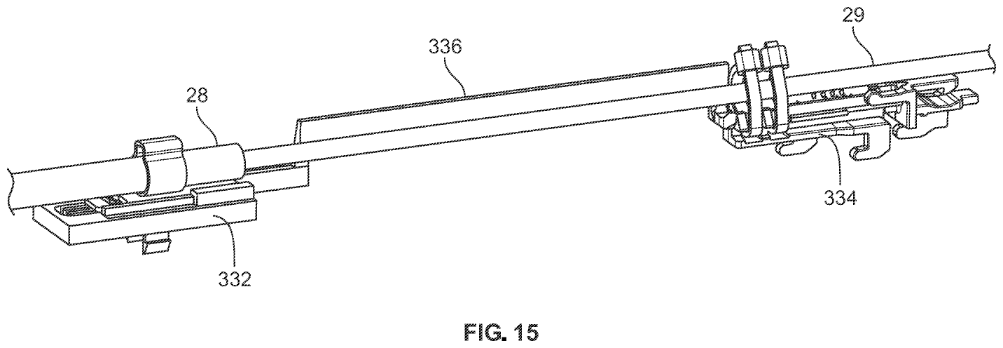

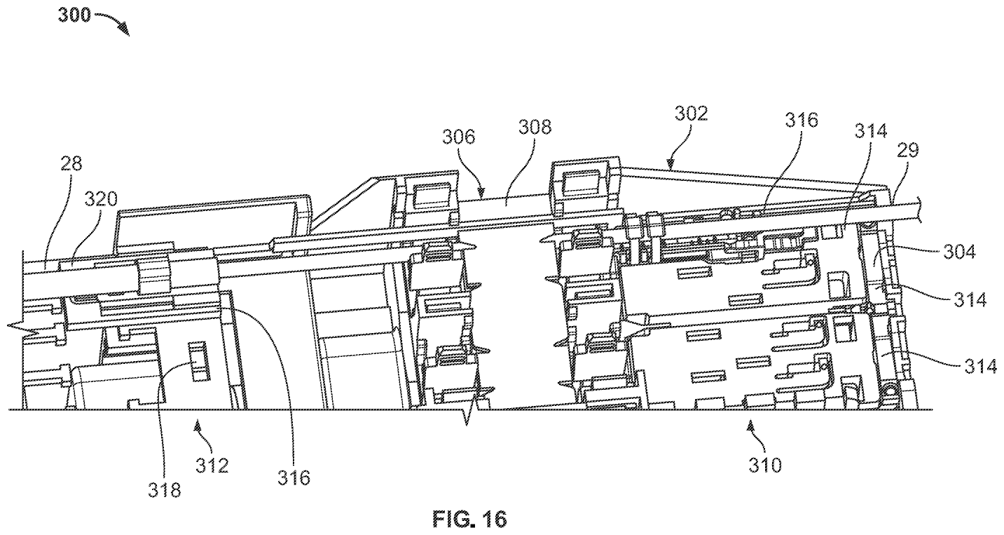

As shown at FIGS. 13-15, the system also includes a fixation component 330 including a fiber tube fixation module 332 and a cable fixation module 334 connected by a bridge 336 that spaces the fiber tube fixation module 332 and the cable fixation module 334 apart a distance equal to the first spacing S.

In use of the fixation component 330, while the fixation component 330 is not yet mounted in the enclosure, a fiber tube 28 can be attached to the fiber tube fixation module 332 (e.g., by strapping, tying, clamping, interlocking with a blade, etc.) and a fiber cable 29 can be attached to the cable fixation module (e.g., by strapping, tying, clamping). After the fiber tube 28 and the fiber cable 29 are attached to the fixation component 330, the fixation component 330 can be used to install the fiber tube fixation module 332 at one of the fiber tube fixation stations 318 and the cable fixation module 334 at a corresponding one of the cable fixation stations 314. The bridge 336 pre-provides the suitable spacing S with the modules 332, 334 pre-positioned such that the cable 29 has minimal to no slack when the modules 332, 334 are attached at their respective fixation stations within the enclosure. As depicted, the end of the fiber tube 28 is spaced away from the outer containment wall 340 for containing the cable sealing arrangement 308. In other examples, the tube end of the fiber tube 28 is in close proximity to the outer containment wall 340. In one example, the tube end of the fiber tube 28 fits within a receptacle (e.g., a tapered receptacle) defined by the outer containment wall 340 so that the fiber cable 29 is supported by the tube 28 to the cable sealant to reinforce the fiber cable 29 against buckling caused by temperature-based expansion/contraction of the fiber tube 28.

As depicted at FIGS. 16 and 17, the bridge 336 extends across the cable sealing arrangement 308 when the fiber tube fixation module 332 and the fiber cable fixation module 334 are being installed at their respective stations. Once the fiber tube fixation module 332 and the fiber cable fixation module 334 are fixed relative to the telecommunication housing 100 at their respective stations, they are fixed in place by the telecommunication housing 100 such that the spacing S is set. Thus, the bridge 336 is no longer needed and can be removed (e.g., by a break-away feature, cutting, etc.) to facilitate sealing at the cable sealing arrangement 308. Thus, the bridge 336 can be removed prior to capturing the cables 29 within the cable sealing arrangement 308. In other examples, the bridge 336 can remain place and the cable sealing arrangement can seal about the bridge 336.

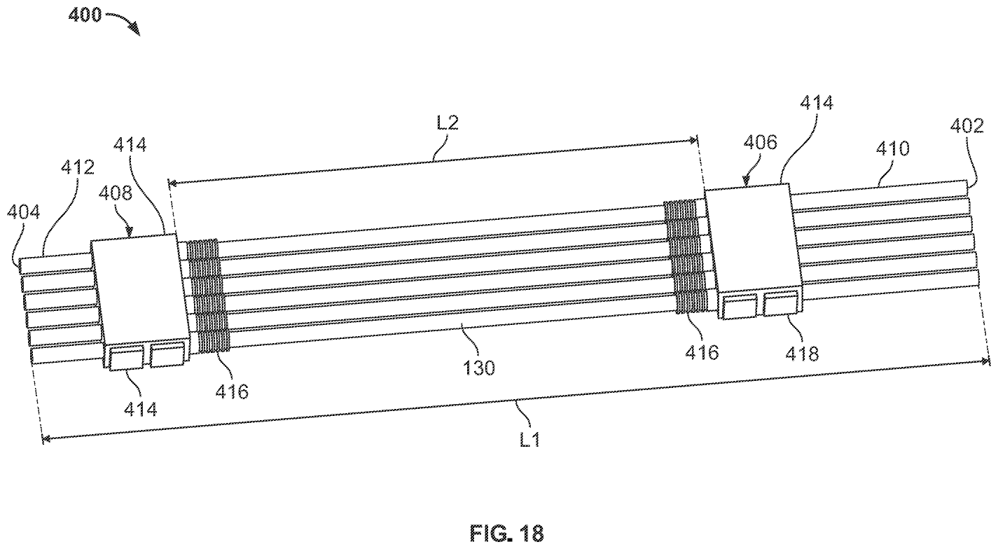

FIG. 18 depicts a tube arrangement 400 in accordance with the principles of the present disclosure that can include protective tubes 130 of the type previously described herein. The protective tubes 130 can be configured for protecting portions 29a of the fiber cables 29. The portions 29a (See FIG. 4) can be configured to extend between the tube sealing unit 110 and the terminal housing 100.

The protective tubes 130 including lengths L1 that extend between first tube ends 402 and opposite second tube ends 404. The tube arrangement 400 also includes first and second fixation blocks 406, 408 molded over the protective tubes 130. The first and second fixation blocks 406, 408 are separated by one another by a spacing L2 that coincides with at least a majority of the length L1 of the protective tubes 130. The protective tubes 130 include first end portions 410 that project axially outwardly from the first fixation block 406 to the first tube ends 402 and the protective tubes 130 include second end portions 412 that project axially outwardly from the second fixation block 408 to the second tube ends 404.

The first and second fixation blocks 406, 408 have molded plastic constructions and each includes a main block body 414 overmolded about the protective tubes 130. The first and second fixation blocks 406, 408 also include resilient, tapered boots 416 corresponding to each of the protective tubes 130. The boots 416 are molded around the protective tubes 130 and provide bend protection to the protective tubes 130. The boots 416 project from the main block bodies 414 and each surrounds a corresponding one of the protective tubes 130. The boots 416 are each unitarily formed with a corresponding one of the main block bodies 414. The boots 416 are positioned between the spaced-apart main block bodies 414 of the fixation blocks 406, 408 and each extends along a portion of the spacing L2. The boots 416 of the first fixation block 406 extend from the main block body 414 of the first fixation block 406 along the spacing L2 toward the second fixation block 408, and the boots 416 of the second fixation block 408 extend from the main block body 414 of the second fixation block 408 along the spacing L2 toward the first fixation block 406. The fixation blocks 406, 408 can also include mechanical interconnect features 418 (e.g., recesses, receptacles, snaps, latches, shoulders, projections, detents, tabs, grooves, etc.) that are unitarily formed with the main block bodies 414 for facilitating mechanically coupling the fixation blocks to brackets such as brackets 420a, 420b.

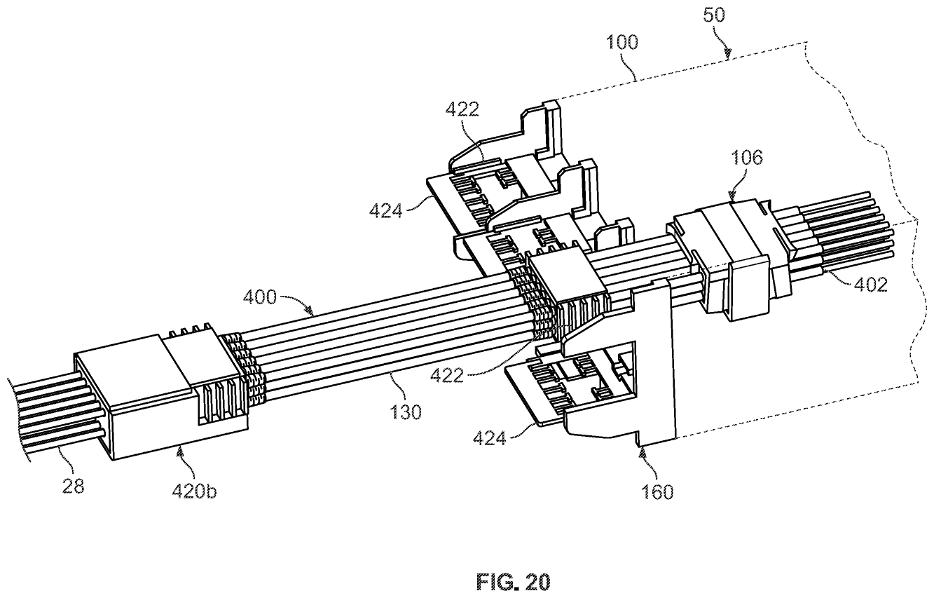

Bracket 420a can be configured for coupling the first fixation block 406 to the bracket arrangement 160 of the enclosure 50 and the bracket 420b can be configured for coupling the second fixation block 408 to the tube sealing unit 110. The bracket 420a can attach to the first fixation block 406 by a connection such as a snap-fit connection arrangement. In one example, the bracket 420a includes linear guides (e.g., rails or grooves) that mate with corresponding linear guide (e.g., rails or grooves) defined by the bracket arrangement 160. In one example, the bracket 420a is retained within a module mounting location 422 (e.g., a receptacle, a pocket, etc.) of the bracket arrangement 160 by latches or other type of snap-fit connection arrangement. As depicted at FIG. 20, cable fixation modules 424 can also be mounted at the module mounting locations 422 with the brackets 420a and the cable fixation modules 424 being interchangeably mountable at the module mounting locations 422. The bracket 420b can be configured for coupling to the tube sealing unit 110 by a mechanical connection arrangement such as a snap fit connection arrangement. With both the tube sealing unit 110 and the second fixation block 408 attached to the bracket 420b, the bracket 420b functions to couple the tube sealing unit 110 and the second fixation block 408 together. In certain examples, multiple fixations blocks 406, 408 corresponding to different ones of the tube assemblies 400 can be stacked within the brackets 420a, 420b such that the brackets coupled the tube assemblies 400 together in a stacked configuration.

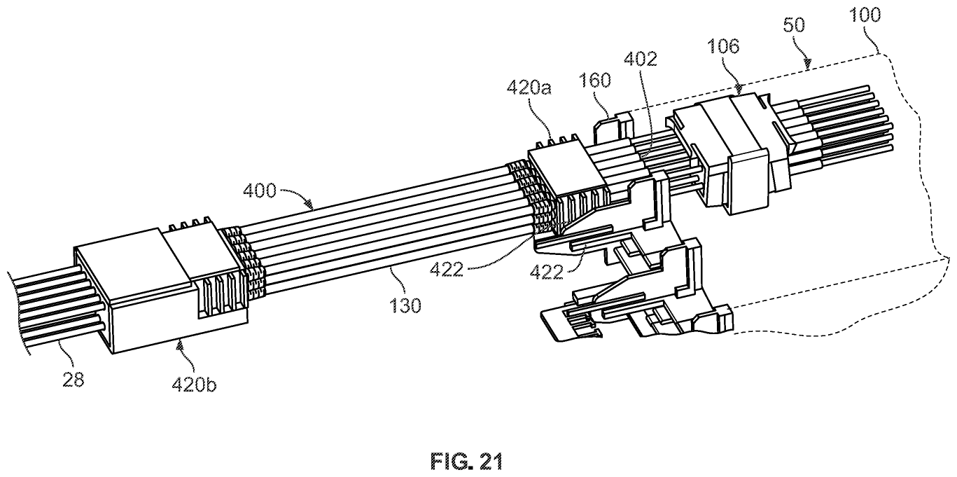

When the tube arrangement 400 is installed in place with respect to the enclosure 50 and the tube sealing unit 110, the first tube ends 402 are positioned adjacent to the cable sealing arrangement 106 and the second tube ends 404 are sealed within the tube sealing unit 110 in co-axial alignment with ends of the fiber tubes 28 that are also sealed within the tube sealing unit 110. In the installation configuration of FIG. 21, the first tube ends 402 stop short of the cable sealing arrangement 106 and are not sealed within the cable sealing arrangement 106, and the cables 29 pass through the cable sealing arrangement 106 and are directly contacted and sealed by the cable sealing arrangement 106. In the installation configuration of FIG. 20, the protective tubes 130 extend through the cable sealing arrangement 106 (e.g., through a sealing module of the cable sealing arrangement 106 as depicted) such that the cable sealing arrangement 106 contacts and seals around the protective tubes 130. In this example, the cables 29 pass through the cable sealing arrangement 106 while being contained within the protective tubes 130 such that the protective tubes 130 prevent contact between the cables 29 and the sealant of the cable sealing arrangement 106. Similar to previous examples, the protective tubes 130 can be more flexible than the fiber tubes 28.

From the forgoing detailed description, it will be evident that modifications and variations can be made in the devices of the disclosure without departing from the spirit or scope of the invention.

1. A fiber optic enclosure system comprising:
an enclosure including a telecommunication housing defining an interior, the telecommunication housing including a cable entrance location at which a cable sealing arrangement is located for sealing about cables routed through the cable entrance location into the interior of the telecommunication housing, the enclosure including a cable fixation region located within the interior of the telecommunication housing; and
a tube sealing unit for receiving fiber tubes adapted to receive fiber cables, the tube sealing unit being located outside the telecommunication housing and including a tube sealing housing defining a plurality of tube receiving locations each configured for receiving one of the fiber tubes, the tube sealing unit also including sealant within the tube sealing housing for sealing the ends of the fiber tubes within the tube sealing housing.

2. The fiber optic enclosure system of claim 1, wherein the fiber tubes have ends located within the tube sealing housing that are sealed by the sealant, wherein the fiber cables extend through the fiber tubes and out of the ends of the fiber tubes, wherein the fiber cables extend through the sealant and out of the tube sealing housing, wherein the fiber cables extend from the tube sealing housing into the interior of the telecommunication housing through the cable sealing arrangement, and wherein the fiber cables are fixed relative to the telecommunication housing at the cable fixation region.

3. The fiber optic enclosure system of claim 1, wherein the tube receiving locations include fixation structures for fixing the fiber tubes relative to the tube sealing housing.

4. The fiber optic enclosure system of claim 3, wherein the fixation structures include blades configured to embed into the fiber tubes.

5. The fiber optic enclosure system of claim 1, further comprising protective tubes that extend between the tube sealing housing and the telecommunication housing for protecting portions of the fiber cables that extend between the tube sealing housing and the telecommunication housing.

6. The fiber optic enclosure system of claim 5, further comprising structure for fixing the protective tubes with respect to the tube sealing housing.

7. The fiber optic enclosure system of claim 5, wherein the protective tubes are more flexible than the fiber tubes.

8. The fiber optic enclosure system of claim 5, wherein the protective tubes each have a wrap-around configuration.

9. The fiber optic enclosure system of claim 1, wherein the tube sealing unit is supported by the telecommunication housing.

10. The fiber optic enclosure system of claim 9, wherein the tube sealing unit mounts to the telecommunication housing via a bracket.

11. The fiber optic enclosure system of claim 10, wherein the tube sealing unit is a module, and wherein the bracket defines a plurality of module mounting locations.

12. The fiber optic enclosure system of claim 11, wherein a plurality of the tube sealing units are concurrently mountable to the bracket.

13. The fiber optic enclosure system of claim 11, wherein the tube sealing unit and a cable fixation module are concurrently mountable to the bracket.

14. The fiber optic enclosure of claim 2, wherein each of the fiber cables includes a jacket, an optical fiber within the jacket and aramid yarn positioned within the jacket.

15. The fiber optic enclosure of claim 5, wherein the tube sealing unit is not supported by the terminal housing.

16. A fiber optic enclosure system for use with fiber tubes through which fiber cables can be deployed, the system comprising:
an enclosure including a telecommunication housing defining an interior, the telecommunication housing including a cable entrance location at which a cable sealing arrangement is located for sealing about the fiber cables when the fiber cables are routed through the cable entrance location into the interior of the telecommunication housing, the enclosure including a cable fixation region located within the interior of the telecommunication housing for securing the fiber cables to the telecommunication housing, the enclosure including a fiber tube fixation region located outside the telecommunication housing for securing the fiber tubes to the terminal housing, the cable fixation region having a plurality of cable fixation stations at which cable fixation modules can be mounted, and the fiber tube fixation region including a plurality of fiber tube fixation stations at which fiber tube fixation modules can be mounted, each of the cable fixation stations being spaced from a corresponding one of the fiber tube fixation stations by a first spacing; and
a fixation component including a fiber tube fixation module and a cable fixation module connected by a bridge that spaces the fiber tube fixation module and the cable fixation module apart at a distance equal to the first spacing, wherein while the fixation component is remote from the enclosure, a fiber tube can be attached to the fiber fixation module and a fiber cable can be attached to the cable fixation module, and wherein after the fiber tube and the fiber cable are attached to the fixation component the fixation component can be used to install the fiber tube fixation module at one of the fiber tube fixation stations and the cable fixation module at a corresponding one of the cable fixation stations.

17. The fiber optic enclosure system of claim 16, wherein the bridge extends across the cable sealing arrangement when the fiber tube fixation module and the fiber cable fixation module are being installed at their respective stations.

18. The fiber optic enclosure system of claim 17, wherein the bridge is removed after the fiber tube fixation module and the fiber cable fixation module have been installed at their respective stations.

19. The fiber optic enclosure system of claim 1, further comprising a tube arrangement including protective tubes for protecting portions of the fiber cables that extend between the tube sealing housing and the telecommunication housing, the protective tubes including lengths that extend between first tube ends and opposite second tube ends, the tube arrangement also including first and second fixation blocks molded over the protective tubes, the first and second fixation blocks being separated from one another by a spacing that coincides with at least a majority of the length of the protective tubes, the protective tubes including first end portions that project outwardly from the first fixation block to the first tube ends and the protective tubes including second end portions that project outwardly from the second fixation block to the second tube ends, the first tube ends being positioned adjacent to the cable sealing arrangement and the second tube ends being sealed within the tube sealing unit in alignment with the fiber tubes.

20. The fiber optic enclosure system of claim 19, wherein the first tube ends stop short of the cable sealing arrangement and are not sealed within the cable sealing arrangement.

21. The fiber optic enclosure system of claim 19, wherein the protective tubes extend through the cable sealing arrangement.

22. The fiber optic enclosure system of claim 19, wherein the protective tubes are more flexible than the fiber tubes.

23. The fiber optic enclosure system of claim 19, wherein the first fixation block is secured to the telecommunication housing by a first connection arrangement that includes at least a first bracket and the second fixation block is secured to the tube sealing unit by a second connection arrangement including at least a second bracket.

24. The fiber optic enclosure system of claim 19, wherein the first and second fixation blocks include main block bodies and resilient, tapered boots that project from the main block bodies, the resilient tapered boots each surrounding a corresponding one of the protective tubes and being unitarily formed with a corresponding one of the main block bodies.
